(19) United States
(12) Patent Application Publication
(10) Pub. No.: US 2025/0219981 A1
(43) Pub. Date: Jul. 3, 2025

(54) MULTI-MODAL DATA HANDLING AND TRANSFER SERVICE ENVELOPE

(71) Applicant: Khoros, LLC, Austin, TX (US)

(72) Inventors: Ryan Studer, Lees Summit, MO (US); Justin August Fellers, Austin, TX (US); Phu Nguyen, Austin, TX (US)

(73) Assignee: Khoros, LLC, Austin, TX (US)

(21) Appl. No.: 19/008,628

(22) Filed: Jan. 2, 2025

Related U.S. Application Data
(60) Provisional application No. 63/617,229, filed on Jan. 3, 2024.

(51) Int. Cl. H04L 51/216; H04L 51/52

(52) U.S. Cl. CPC H04L 51/216; H04L 51/52

(57) ABSTRACT

Multi-modal service envelope techniques are described, including initiating a public conversation thread between an account and an entity using a messaging application, detecting a public conversation thread data request being directed by the account to the entity, initiating a private direct messaging thread between the account and the entity in response to the public conversation thread data request, and detecting a transfer request from the account, the transfer request being configured to responsively transfer the public conversation thread between the account and the entity to the private direct messaging thread between the account and the entity to a platform using a multi-modal service envelope

### CROSS-REFERENCE TO RELATED APPLICATIONS

This nonprovisional patent application claims the benefit of U.S. Provisional Patent Application No. 63/617,229, filed Jan. 3, 2024 and entitled, “MULTI-MODAL DATA HANDLING AND TRANSFER SERVICE ENVELOPE,” all of which is herein incorporated by reference in its entirety for all purposes.

### FIELD

The present invention relates generally to software, computer science, data science, and user interface and user experience design and development. More specifically, multi-modal data handling and transfer service envelope techniques are described.

### BACKGROUND

Widespread adoption and use of social media and social networks has generated enormous commercial and retail opportunities for various types of entities, organizations, corporations, and individuals alike. Using social media channels and networks, entities such as consumer packaged goods (i.e., “CPG”) companies, manufacturers, distributors, and retailers can promote goods and services while informing prospective purchasers and consumers of various and wide ranging types of information, including product features, benefits, and safety data, among others.

However, conventional solutions for implementing software-based processing techniques, including the handling of massive amounts of information, often described as events or transactions, is problematic, at best. Social media channels and networks contend with problems and endemic issues ranging from latency to scale when performing event handling and processing, often requiring the expenditure of enormous costs to produce and implement computing architectures capable of managing large scale data traffic. For example, X™, formerly known as Twitter®, of San Francisco, California, contends with massive scaling of its data operations, using organic and outside computing resources such as Google® Cloud and Kafka® to process synchronous and asynchronous event data traffic. Merely handling user data traffic and event data resulting from user activity creates enormous computing and personnel requirements for X™, let alone other social media channels and networks. Adding additional features to create incentives for users to not only use its platform, but to increase usage, is an enormous area of investment not only for X™, but most, if not all, social media channels and networks. While messaging often is the most promoted feature on most social media channels and networks, conventional solutions often do not implement other attractive features for fear of creating enormous costs and investment requirements or overextending technical capabilities and capacities beyond current levels, which could risk catastrophic events such as servers and data centers being overwhelmed rendering services unavailable or slow, cybersecurity vulnerabilities, increasing costs and expenses, and, ultimately, user base degradation, among many other deleterious effects. The resistance to innovation created by these risks are inherent in conventional solutions and prevents new and novel features from being deployed for user benefit, both public and private alike.

Thus, what is needed is seamless data transfer and handling of different types of data that permit interaction with consumers and purchasers without the limitations of conventional techniques.

### BRIEF DESCRIPTION OF THE DRAWINGS

Various embodiments of the invention are disclosed in the following detailed description and the accompanying drawings:

FIG. 1 illustrates an exemplary data network topology for a multi-modal data transfer and handling service envelope;

FIG. 2 illustrates an exemplary system for a multi-modal data transfer and handling service envelope;

FIG. 3 illustrates an exemplary user interface for a multi-modal data transfer and handling service envelope;

FIG. 4A illustrates an exemplary interface for multi-modal data transfer and handling;

FIG. 4B illustrates another exemplary interface for multi-modal data transfer and handling;

FIG. 4C illustrates a further exemplary interface for multi-modal data transfer and handling;

FIG. 5 illustrates yet another exemplary interface for multi-modal data transfer and handling;

FIG. 6 illustrates an exemplary process for multi-modal data transfer and handling; and

FIG. 7 illustrates an exemplary computer system suitable for a multi-modal data transfer and handling service envelope.

### DETAILED DESCRIPTION

Various embodiments or examples may be implemented in numerous ways, including as a system, a process, an apparatus, a user interface, or a series of program code or instructions on a computer readable medium such as a storage medium or a computer network including program instructions that are sent over optical, electronic, electrical, chemical, wired, or wireless communication links. In general, individual operations or sub-operations of disclosed processes may be performed in an arbitrary order, unless otherwise provided in the claims.

A detailed description of one or more examples is provided below along with accompanying figures. This detailed description is provided in connection with various examples, but is not limited to any particular example. The scope is limited only by the claims and numerous alternatives, modifications, and equivalents. Numerous specific details are set forth in the following description in order to provide a thorough understanding. These details are provided for the purpose of illustrating various examples and the described techniques may be practiced according to the claims without some or all of these specific details. For clarity, technical material that is known in the technical fields and related to the examples has not been described in detail to avoid unnecessarily obscuring the description or providing unnecessary details that may be already known to those of ordinary skill in the art.

As used herein, “system” may refer to or include the description of a computer, network, or distributed computing system, topology, or architecture using various computing resources that are configured to provide computing features, functions, processes, elements, components, or parts, without any particular limitation as to the type, make, manufacturer, developer, provider, configuration, programming or formatting language (e.g., Python™, R, JAVA®, JAVASCRIPT®, XML, HTML, and others, without limitation or restriction), service, class, resource, specification, protocol, or other computing or network attributes. As used herein, “software” or “application” may also be used interchangeably or synonymously with, or refer to a computer program, software, program, firmware, or any other term that may be used to describe, reference, or refer to a logical set of instructions that, when executed, performs a function or set of functions within a computing system or machine, regardless of whether physical, logical, or virtual and without restriction or limitation to any particular implementation, design, configuration, instance, or state. Further, “platform” may refer to any type of computer hardware (hereafter “hardware”) and/or software using, hosted on, served from, or otherwise implemented on one or more local, remote, and/or distributed data networks such as the Internet, one or more computing clouds (hereafter “cloud”), or others. Data networks (including computing clouds) may be implemented using various types of standalone, aggregated, or logically-grouped computing resources (e.g., computers, clients, servers, tablets, notebooks, smart phones, cell phones, mobile computing platforms or tablets, and the like) to provide a hosted environment for an application, software platform, operating system, software-as-a-service (i.e., “SaaS”), platform-as-a-service, hosted, or other computing/programming/formatting environments, such as those described herein, without restriction or limitation to any particular implementation, design, configuration, instance, version, build, or state. Distributed resources such as cloud computing networks (also referred to interchangeably as “computing clouds,” “storage clouds,” “cloud networks,” or, simply, “clouds,” without restriction or limitation to any particular implementation, design, configuration, instance, version, build, or state) may be used for processing and/or storage of varying quantities, types, structures, and formats of data, without restriction or limitation to any particular implementation, design, or configuration. In the drawings provided herewith, the relative sizes and shapes do not convey any limitations, restrictions, requirements, or dimensional constraints unless otherwise specified in the description and are provided for purposes of illustration only to display processes, data, data flow chart, application or program architecture or other symbols, as described in this specification.

As described herein, structured and unstructured data may be stored in various types of data structures including, but not limited to databases, repositories, warehouses, datalakes, lakehouses, data stores, and other data structures and facilities configured to manage, store, retrieve, process calls for/to, copy, modify, or delete data or sets of data (i.e., “datasets”) in various computer programming languages and formats (e.g., structured, unstructured, binary, and others) in accordance with various types of structured and unstructured database schemas and languages such as SQL®, MySQL®, NOSQL™, DynamoDB™, R, or others, such as those developed by proprietary and open source providers like Amazon® Web Services, Inc. of Seattle, Washington, Microsoft®, Oracle®, Google®, Salesforce.com, Inc., and others, without limitation or restriction to any particular schema, instance, or implementation. Further, references to databases, data structures, or any type of data storage facility may include any embodiment as a local, remote, distributed, networked, cloud-based, or combined implementation thereof, without limitation or restriction. In some examples, data may be formatted and transmitted (i.e., transferred over one or more data communication protocols) between computing resources using various types of wired and wireless data communication and transfer protocols such as Hypertext Transfer Protocol (HTTP), Transmission Control Protocol (TCP)/Internet Protocol (IP), Internet Relay Chat (IRC), SMS, text messaging, instant messaging (IM), WiFi, WiMax, or others, without limitation. Further, as described herein, disclosed processes implemented as software may be programmed using JAVA®, JAVASCRIPT®, Python, R, Scala, Perl, XML, HTML, or other data formats and programming languages, without limitation. As used herein, references to layers of an application architecture (e.g., application layer or data layer) may refer to a stacked layer application architecture designed and configured using models such as the Open Systems Interconnect (OSI) model or others.

The described techniques may be implemented as a software-based application, platform, or system. In some examples, machine learning, deep learning, neural network, and other types of computing, processing, and analytical algorithms such as those used in various computer science-related fields may be used to implement techniques related to “artificial intelligence” (i.e., “AI”), generative pre-trained transformers (i.e., “GPT”), transformers, or other generative artificial intelligence (e.g., such as “chatbots” and other types of guided and unguided, autonomous, or other types of AI applications such as those developed by OpenAI™, Microsoft®, Google® (e.g., Bard), Apple, Stability AI (e.g., Stability Diffusion), MidJourney™, and others, without limitation or restriction) including, but not limited to, any type of large language model and/or transformer. While there is no particular dependency to a given type of model (e.g., large language model (“LLM”)) or algorithm (e.g., artificial intelligence (“AI”), machine learning, deep learning, neural networks, intelligent agents, or any other type of algorithm that, through the use of computing machines, attempts to simulate or mimic certain attributes of natural intelligence such as cognitive problem solving, without limitation or restriction), there is likewise no requirement that only a single instance or type of a given algorithm or dataset be used in the implementations described. Algorithms may be untrained or trained using model data, external data, internal data, or other public or private sources of data that may be used to improve the accuracy of calculations performed or trained to generate output data for use in applications, systems, or platforms in data communication with software module or engine-based implementations. The techniques described herein are not limited to any specific implementation, design, function, operation, structure, configuration, specification, or other characteristics or attributes and may be varied without limitation or restriction. The size, shape, quantity, configuration, function, or structure of the elements shown in the various drawings may be varied and are not limited to any specific implementations shown. Drawings accompanying this Specification are provided for exemplary purposes of illustration and are not intended to be limiting.

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including C, Objective C, C++, C#, Adobe® Integrated Runtime™ (Adobe® AIR™), ActionScript™, Flex™, Lingo™, Java™, Javascript™, Ajax, Perl, COBOL, Fortran, ADA, XML, MXML, HTML, DHTML, XHTML, HTTP, XMPP, and others. Design, publishing, and other types of applications such as Dreamweaver®, Shockwave®, Flash®, and Fireworks® may also be used to implement the described techniques. The described techniques may be varied and are not limited to the examples or descriptions provided.

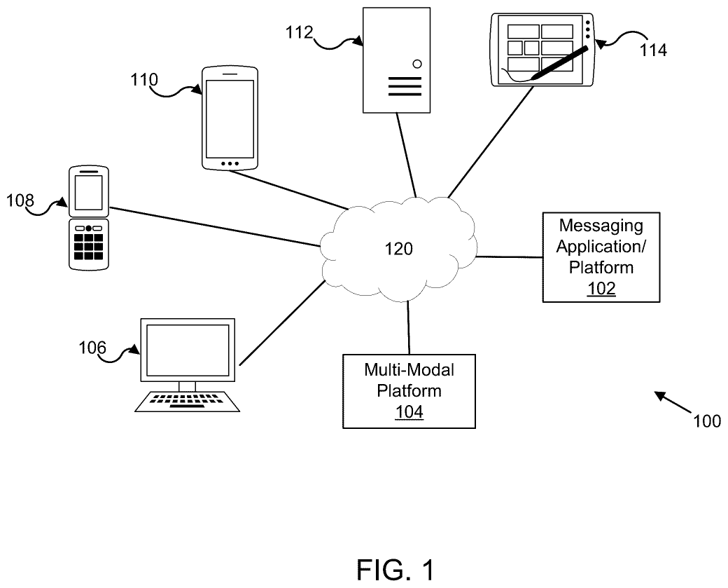

FIG. 1 illustrates an exemplary data network topology for a multi-modal data transfer and handling service envelope. Here, topology 100 includes messaging application/platform 102, multi-modal platform 104, and clients 106-114. In some examples, messaging application/platform 102 may be implemented as a large-scale messaging application, platform, system, or channel such as X™ (formerly known as Twitter®), Facebook® of Menlo Park, California, Instagram® of Menlo Park, California, YouTube® of San Bruno, California, Snapchat® of Venice Beach, California, and others, without limitation or restriction. Data transferred between clients 106-114 over data network 120 may be initiated on messaging application/platform 102 and, using the techniques described in this Detailed Description, seamlessly transferred from messaging application/platform 102 to multi-modal platform 104 in order to render a transparent or apparently seamless user experience (i.e., “UX”) to one or more (i.e., thousands, millions, billions, and the like) of clients 106-114. As used herein, a “multi-modal platform” (e.g., multi-modal platform 104 or platform 104, as used herein interchangeably and without limitation or restriction) may refer to a data transfer and management platform configured to be used for various types of computing purposes such as managing customer or consumer messaging applications for customer or product support, brand management of data for various or particular brands on different types of social media networks and channels (without limitation or restriction), service engagement, sales engagement, or other processes and functions, such as those described herein.

For example, platform 104 may be configured to monitor, manage, or implement a data communication platform that may be used to engage customers using various types of data communication devices, such as mobile or smart phones, computers (e.g., desktops, laptops, tablets, or others), or others in order to initiate connections or communication sessions with a given product's brand, customer, consumer, or support agents. Platform 104 may be, in some examples, used to manage, monitor, and control the underlying data architecture that enables these communication, conversation, or messaging sessions over various types of media, protocols, channels, or the like. TCP/IP, SMS, RCS, text, email, HTTP, HTTPS, and many others are examples of data communication protocols that may be used for communication between a consumer or customer and an agent (e.g., a person, natural or artificial) assigned to provide online or data-based assistance to resolve a problem with a given product or service. Once initiated, these sessions may be managed by platform 104 to transfer a given session to an appropriately matched agent, in accordance with techniques such as those described herein.

As an example, a communication or conversation between a consumer and a brand (i.e., a natural or artificial person or agent assigned by a brand entity to engage a consumer or customer (i.e., the public) in order to provide a service or support assistance) may be managed by platform 104 and, using various analytical processes, algorithms, models, or other logic, such as those described herein, transfer the conversation seamlessly and automatically to an agent or a different agent in order to continuously improve the quality of engagement (e.g., sales engagement, service engagement, support engagement, help engagement, or the like, without restriction or limitation to a particular type of engagement), thus improving perceived quality or “brand perception” in order to foster public loyalty to a given brand entity's products or services, or other beneficial purposes, including those described herein. The number, type, configuration, and topology of the elements shown and described may be varied and are not limited to those provided.

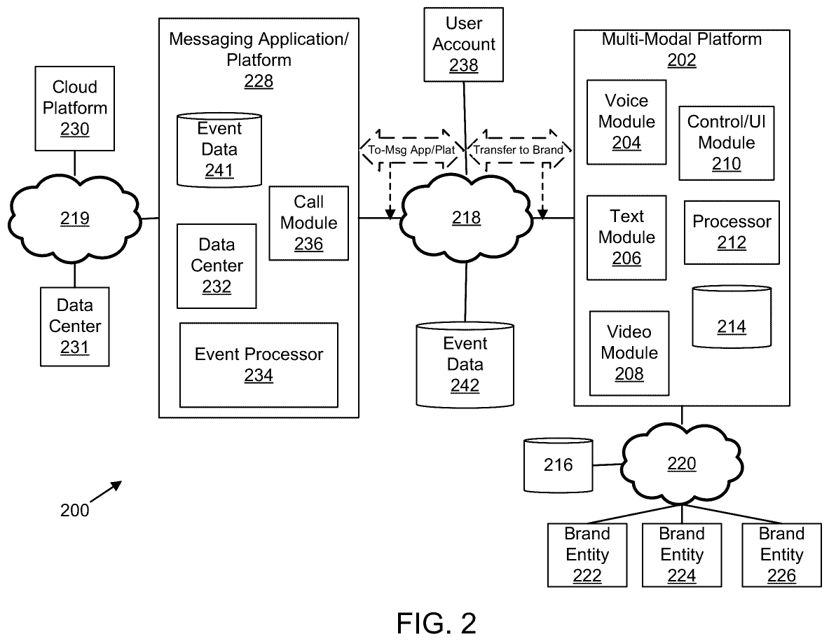

FIG. 2 illustrates an exemplary system for a multi-modal data transfer and handling service envelope. Here, system 200 includes multi-modal data transfer and handling platform (“multi-modal data transfer and handling platform” may be used interchangeably and synonymously with “multi-modal platform,” without limitation, distinction, differentiation, or restriction), voice module 204, text module 206, video module 208, control/UI module 210, processor 212, databases 214-216 (which may be implemented using any type of data storage implementation, logical or physical), data networks 218-220, brand entities 222-226, messaging application/platform 228, cloud platform 230, data centers 231-232, event processor 234, call module 236, user account (i.e., client (as in clients 106-114 (FIG. 1))) 238, and event data 240-242. In some examples, messaging may be implemented using messaging application/platform 228, which may be configured to be hosted on cloud platform 230 and use external and internal data centers (e.g., data center 231 and data center 232, respectively), without regard to a specific cloud platform developer or data center provider/operator. Event data queried, stored, and transferred in event databases 241 and 242 (i.e., internal and external; event databases 241 and 242, respectively) can be transferred or transmitted over one, some, or all of data networks 218-220. In some examples, data networks 218-220 may be any type of private or public data network or data network infrastructure, without regard to a specific providers or operators.

Here, messaging application platform 228 may be used by user account 238 to generate, send, and receive messages on various platforms such as those described above. For example, messages posted on X™, formerly known as “tweets” being posted to Twitter®, a popular social media and instant messaging account based in San Francisco, California, may be transferred (as shown by the broken line arrow) to messaging platform 228. When received using call module 236, event data may be stored in one or more of event databases 241-242 and processed using various types of applications, algorithms, or services hosted or offered on data centers 231-232 in data communication with messaging platform 228. In other examples, when messaging application/platform 228 or multi-modal platform 202 detect data within a public conversation thread (i.e., public conversation thread data) in which user account 238 is participating with one or more of brand entities 222-226, multi-modal platform 202 (using algorithms, analytical processes, or various types of “AI,” large language models, transformers, or other types of logic) can invoke or call one or more of voice module 204, text module 206, or video module 208 using control/UI module 210 to generate a private direct messaging thread using voice, text, or video, respectively, data communication link between one or more of brand entities 222-226 over data network 218, storing public conversation thread data or private direct messaging data in internal database 214 or external database 220, one or either of which may be implemented using any type of database, data store, data warehouse, or other data storage facility. In other words, a public conversation thread between an account user on a messaging application/platform 228 and one or more of brand entities 222-226 can be transformed into a private direct messaging thread between user account 238 and one or more of brand entities 222-226, thus removing the public conversation thread from publication or public dissemination on messaging application/platform 228.

In some examples, a private direct messaging thread may be a voice call between user account 238 (i.e., implemented by call module 236 and/or voice module 204 on multi-modal platform 202) and one or more of brand entities 222-226, which may be implemented as a direct voice call between a consumer (e.g., user account 238) and a contact or call center or product or service help center support agent (e.g., brand entity 222-226) and which may be further managed for escalation to various internal functions or other personnel within brand entities 222-226, as described in greater detail below. As another example, multi-modal platform may detect certain words, tones, tonal inflections, facial features, context, semantics, heuristics, or other detect attributes or characteristics to suggest user account 238 may prefer or be desirous of a different type of messaging connection apart from a public conversation thread. For example, multi-modal platform 202 may detect from data transferred over data network 218 from user account 238 and sampling or other analysis performed on event data stored in event data 242, that a video call with one or more of brand entities 222-226 may have a higher threshold score indicative of matching the attributes or characteristics noted. For example, user account 238 may be receptive, as detected by multi-modal platform 202 from a public conversation thread, that a video call enabled and managed by video module 208 between user account 238 and one or more of brand entities 222-226 may be more successful at resolving a public conversation data thread request or transfer request than a text messaging application; thus, a video call may be instantiated by multi-modal platform 202 and video module 208 with a transfer request to transfer a public conversation thread hosted by messaging application/platform 228 to another messaging application/platform configured for video communication, or the like, without limitation or restriction. In other examples, different types of communication exchanges or data communication protocols used between user account 238 and brand entities 222-226 may be used, without limitation or restriction. Further, the type, configuration, function, structure, computing architecture, topology, and arrangement of the elements shown in FIG. 2 may be varied, without limitation or restriction. Further, the sizes and shapes of the elements shown in any drawing throughout this Detailed Description may also be varied without specific limitation or restriction to any particular function or structure shown and described.

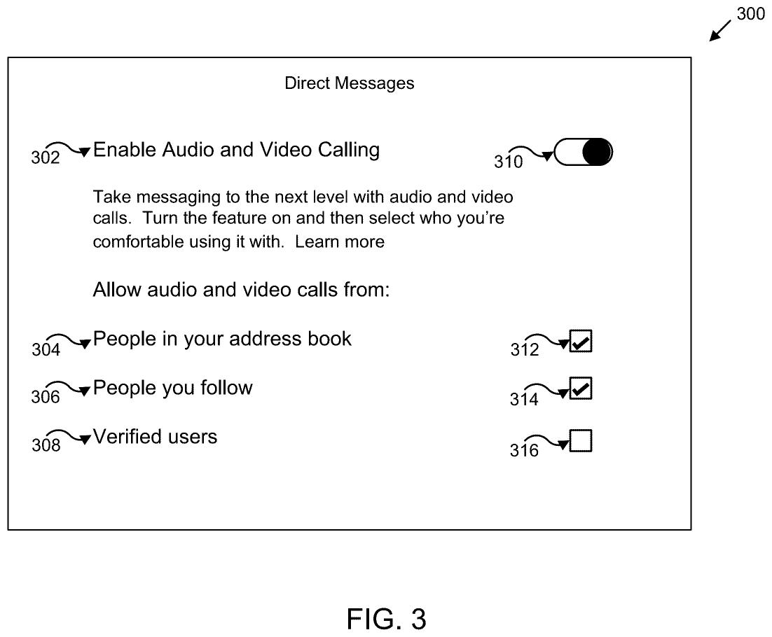

FIG. 3 illustrates an exemplary user interface for a multi-modal data transfer and handling service envelope. Here, interface 300, as shown, includes settings 302-308 and settings functions 310-316. In some examples, interface 300 may be an example of a mobile application interface installed on a mobile device (e.g., smart phone, tablet computer, wearable, or other portable or non-portable computing device, without limitation or restriction) that, when a messaging application (e.g., served by messaging application/platform 228 (FIG. 2)) that is configured to permit a user (e.g., user account 238 (FIG. 2)) to configure permissions or other settings that enable direct messaging or communication links with a brand (e.g., one or more of brand entities 222-226 (FIG. 2)).

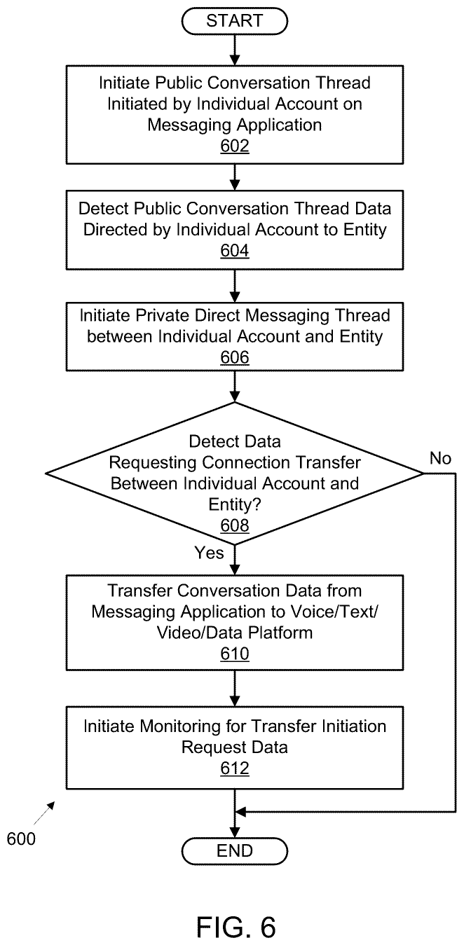

For example, by enabling the “sliding” control of settings function 310, user account 238 (FIG. 2) is enable for audio and video calling with one or more of brand entities 222-226 (FIG. 2) using voice module 204 as controlled and managed by control/UI module 210. Further, once settings function 310 is enabled, other settings functions may appear, such as settings functions 312-316, the latter of which may be used to refine, for privacy and security purposes, who user account 238 (FIG. 2) may be seamlessly transferred from a public conversation thread to a private direct messaging thread. For example, “seamless” or “seamlessly transferring” a public conversation thread to a private direct messaging thread, as described below in connection with FIG. 6, may occur in a real-time or near real-time manner (i.e., little to no latency other than that typically experienced when using a messaging application such as X™) during which public conversation thread data sampled by multi-modal platform 202 (FIG. 2) detects or indicates involvement or association of a “brand” (e.g., for example, data being served or managed by one or more of brand entities 222-226). When detected in the sampled data, multi-modal platform 202 coordinates over data network 218 with messaging application/platform 228 to generate a private direct messaging thread between user account 238 and one or more of brand entities 222-226 (FIG. 2). As a result of the private direct messaging thread, a further data communication link may be generated in which, for example, a VoIP call or video call (e.g., Skype® as provided by Microsoft Corporation of Redmond, Washington, FaceTime® as provided by Apple, Inc. of Cupertino, California, or others, without limitation or restriction) can be further established to allow private, direct communication between user account 238 and one or more of brand entities 222-226. By enabling private direct messaging or private direct data communications, regardless of whether video, audio, or text-based, permits greater commercial opportunities for brands to engage with consumers, customers, patrons, and the like. Although the context of the examples shown are describing commercial applications, the ability to seamless transfer users (e.g., user account 238 (FIG. 2)) from public conversation threads to private direct messaging threads (i.e., convert users from public data to private data exchanges) provides an appealing, secure, and reliable manner of using multi-modal platform 202 (such as that provided by Khoros, LLC of Austin, Texas) between users and any type of organization with a public online (i.e., on the Internet, World Wide Web (hereafter “web”), or other type of data network) “presence.”

In some examples, algorithms implemented, instanced, and executed by one or both of messaging application/platform 228 and multi-modal platform 202 may be used to determine when and how to switch or transfer user account 238 from a public conversation thread to a private direct messaging data thread (i.e., as used herein, “private direct messaging data thread” and “private direct messaging thread” may be used interchangeably without limitation or restriction) or data communication link, as indicated by the broken line arrows of FIG. 2. In other examples, the function and structure of the elements shown may be varied, without limitation or restriction.

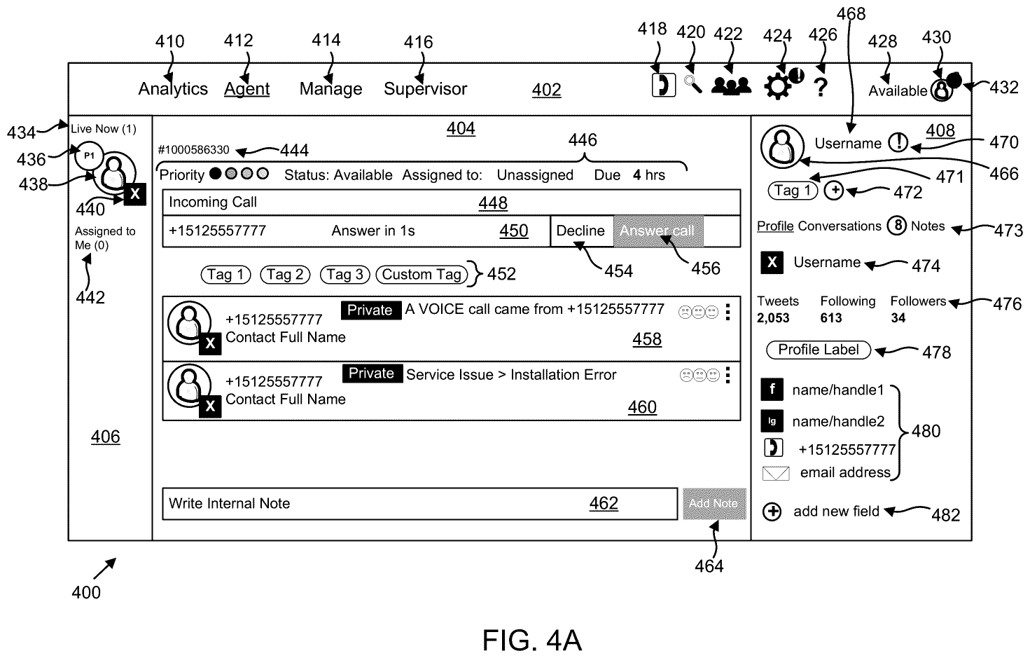

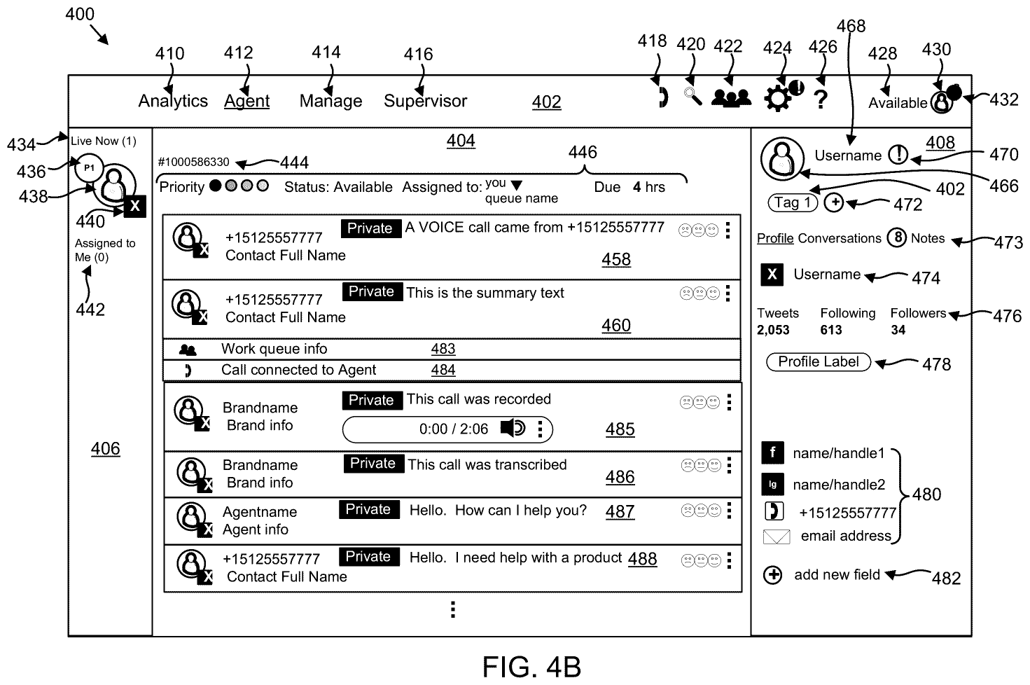

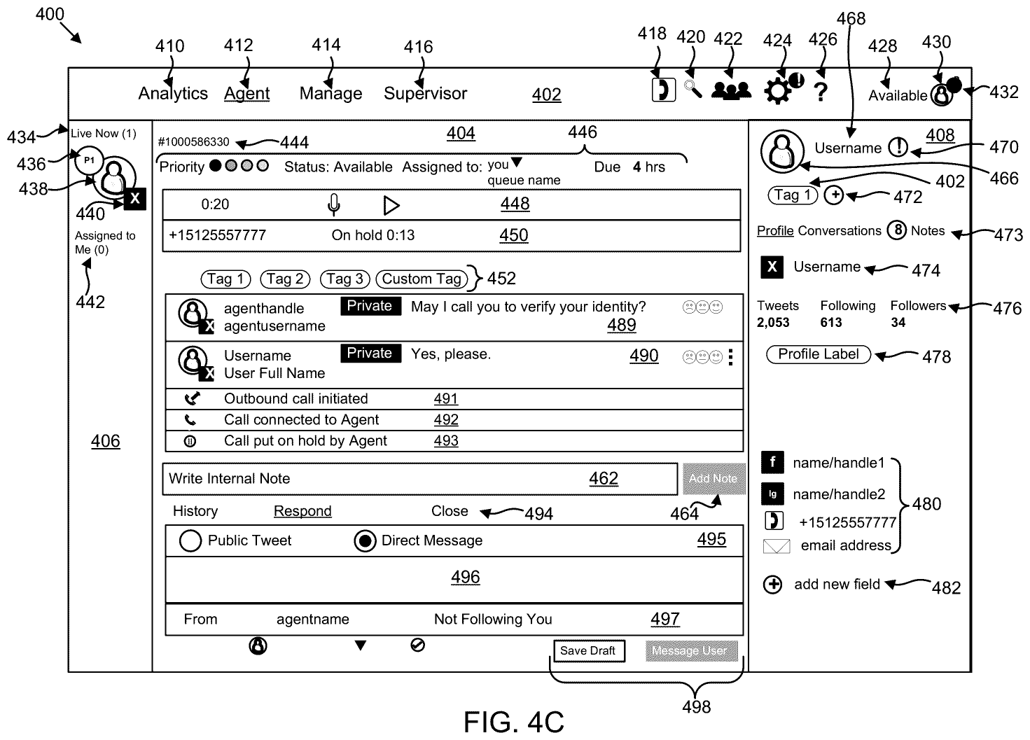

FIG. 4A illustrates an exemplary interface for multi-modal data transfer and handling. Here, wireframe interface (hereafter “interface”) 400, as shown, includes header window 402, windows 406-408, options 410-416, functions 418-426, status features 428-442, case number 444, case status features 446, application status features 448-456, metadata tags (hereafter “tags”) 452, information windows (hereafter “info windows”) 458-460, notation features 462-464, user information features 466-472, user menu options 473, user activity indicators 476, profile label 478, user contact and channel information (hereafter “user contact information”) 480, and new field function 482. In some examples, interface 400 may be used to provide internal corporate users of messaging application 228, multi-modal platform 202, or brand entities 222-226 with a control and management interface for invoking features and functionality of multi-modal platform 202 to control seamless transfer of user accounts from public conversation threads to private direct messaging, regardless of whether voice, text, or video-based. Here, options 410-426 in header window 402 may present different options to, for example, an agent (i.e., an internal user such as a corporate employee (e.g., customer support agent, customer service agent, product support agent, and the like, without limitation or restriction) of messaging application/platform 228 (FIG. 2) or brand entities 222-226) to select different interfaces for managing the engagement of users being seamlessly transferred from public conversation threads on messaging application/platform 228 (FIG. 2) to private direct messaging threads with brand entities 222-226. Options 410-416 may be used, in some examples, to invoke different presented displays on interface 400 such as “Analytics,” “Agent,” “Manage,” or “Supervisor” features and functionality. Functions 418-426 may be used to also invoke call, search, group, setting, or help/information features as well. Status features 428-430 can provide widgets or elements for displaying a given user or agent's availability, avatar, icon, or other user indicia. Further, status features 434-442 can indicate whether a given private direct messaging thread is live, dead, terminated, ended, or the like (e.g., status feature 434), as well as an assigned priority (e.g., status feature 436), user image or icon (e.g., status feature 438), and feature that permits termination (e.g., status feature 440) of the current active thread as well as indicating assignment status (e.g., status feature 442).

In some examples, window 404 may be the primary working window for an agent using multi-modal platform 202 (FIG. 2) to establish, manage, or terminate private direct messaging threads with user(s) transferred from public conversation threads with one or more brands (i.e., brand entities 222-226) (FIG. 2). Here, numbers assigned to a given private direct messaging thread (i.e., case number 444) may be displayed, along with various types of priority and case status features 446. Any of the described features or elements may be implemented as interactive features and are not limited to any particular static function described, without limitation or restriction.

Referring back to FIG. 4A, a status or warning label may be provided using application status feature 448 when private direct messaging thread data indicates an incoming request for a voice call (as identified by application status feature 450) is being received (i.e., “incoming”) and application status features 452-456 may be used to assign metadata (i.e., “tag”), decline, or answer a call. Further, info windows 458-460 may be configured to present historical event, status, or activity data for a given private direct messaging thread, call or other data communication link with a user (e.g., user account 238 (FIG. 2)).

In some examples, window 408 may be used to display additional information on a given user, including information features 466-472, user menu options 473, user activity indicators 476, profile label 478, user contact and channel information (hereafter “user contact information”) 480. Here, in window 408, user profile information can be displayed to assist an agent with assisting a user engaged in a private direct messaging thread or call with brand entities 222-226, including providing alternate forms of contact or engagement with a given user, including other social media channels and networks, as shown by user contact information 480. Still further, user profile information displayed in window 408 may be configured or customized using new field function 482. In other examples, the configuration, layout, function, and structure of the elements of interface 400 as shown may be varied, without limitation or restriction.

FIG. 4B illustrates another exemplary interface for multi-modal data transfer and handling. Here, interface 400, as shown, also includes (when actions are taken such as those described above, among others, in connection with FIG. 4A) header window 402, windows 406-408, options 410-416, functions 418-426, status features 428-442, case number 444, case status features 446, application status features 448-456, metadata tags (hereafter “tags”) 452, information windows (hereafter “info windows”) 458-460, notation features 462-464, user information features 466-472, user menu options 473, user activity indicators 476, profile label 478, user contact and channel information (hereafter “user contact information”) 480, new field function 482, and info windows 483-488. As used throughout, like-numbered elements may be used to refer to similar features, functions, or structures that, although presented in a different drawing or view, are used to provide context or understanding for a given figure. For example, interface 400 and elements 402-482 are intended to be similar to those shown and described above in connection with FIG. 4A. Elements 483-488, specifically, info windows 483-488 are used to display different information to an agent using multi-modal platform 202 (FIG. 2).

Here, info windows 483-488 may be used to display historical data or information regarding a private direct messaging thread (458), transcription data or information associated with a call, as performed by multi-modal platform 202 (FIG. 2) (460, 486-488), or additional information associated with a call, which an agent may find valuable. For example, an agent may view work queue data and information in info window 483 to understand how the present private direct messaging thread or call relates to her present queue assignments. Info window 484 may also be displayed to provide information to an agent to alert and maintain a physical status that a call with user account 238 (FIG. 2) is active. In other examples, the configuration, layout, function, and structure of the elements of interface 400 as shown may be varied, without limitation or restriction.

FIG. 4C illustrates a further exemplary interface for multi-modal data transfer and handling. Here, interface 400, as shown, further includes (when actions are taken such as those described above, among others, in connection with FIGS. 4A-4B) includes header window 402, windows 406-408, options 410-416, functions 418-426, status features 428-442, case number 444, case status features 446, application status features 448-456, metadata tags (hereafter “tags”) 452, information windows (hereafter “info windows”) 458-460, notation features 462-464, user information features 466-472, user menu options 473, user activity indicators 476, profile label 478, user contact and channel information (hereafter “user contact information”) 480, new field function 482, and info windows 489-493, messaging data features 494, messaging status window 495, messaging window 496, message attributes 497, and messaging options 498. As used throughout, like-numbered elements may be used to refer to similar features, functions, or structures that, although presented in a different drawing or view, are used to provide context or understanding for a given figure. For example, interface 400 and elements 402-482 are intended to be similar to those shown and described above in connection with FIG. 4A. New elements info windows 489-493, messaging data features 494, messaging status window 495, messaging window 496, message attributes 497, and messaging options 498 are shown to provide additional detail and examples of calls initiated from private direct messaging threads with user account 238 (FIG. 2).

In some examples, info windows 489-493 may be displayed to provide additional transcription details of a call, including whether a given call is “private” (i.e., initiated as a private direct messaging (e.g., voice) thread between an agent and user account 238 (FIG. 2) using multi-modal platform 202 (FIG. 2)) (489-490). Further, call status or actions associated with a call can be further and individually displayed in info windows 491-493, along with the ability for a user to add notation to a given call using note features 462-464. In other examples, features may be provided and displayed by multi-modal platform 202 (FIG. 2) in interface 400 to present data and information that may be specifically generated, harvested, queried, presented, stored, or displayed by, for example, messaging application/platform 228 (FIG. 2). For example, messaging status window 495, messaging window 496, message attributes 497, and messaging options 498 may be used to present information that is tailored or customized for a given messaging application, social media channel or network, or the like. Here, messaging status window 495, messaging window 496, message attributes 497, and messaging options 498 are customized and tailored for X™, the social messaging channel/network formerly known as Twitter®. In other examples, messaging status window 495, messaging window 496, message attributes 497, and messaging options 498 may be customized, added to, deleted, or otherwise modified for other social media channels, networks, or platforms, without restriction or limitation to those examples shown and described. In other examples, the configuration, layout, function, and structure of the elements of interface 400 as shown may be varied, without limitation or restriction.

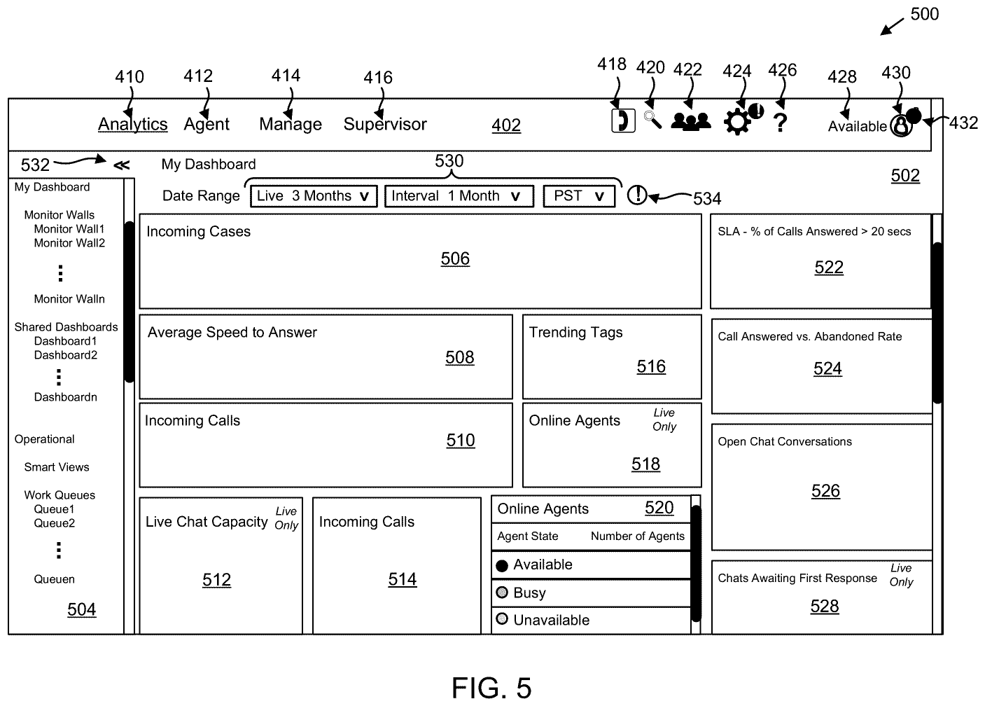

FIG. 5 illustrates yet another exemplary interface for multi-modal data transfer and handling. Here, interface 500, as shown, includes header window 402, windows 406-408, options 410-416, functions 418-426, status features 428-432, info windows 502-528, filter options 530, control 532, and information retrieval control 534. In some examples, interface 500 may be displayed when option 410 (i.e., “Analytics”) is invoked in order to display data analytics and historical data for a given call, agent performance history, work queue, or the like. Data may be presented in one, some, or any of windows 502-528 using various types of data presentation and analysis techniques such as pie charts, graphs, bar charts, text, or others, without limitation or restriction. As an example, window 504 may be displayed to provide a customer support or service agent or other user managing multi-modal platform 202 (FIG. 2) with the ability to monitor various monitor walls, queues, or other work-related assignments, groups, or functions to which he is assigned.

As another example, relevant attributes for a given agent may be presented such as Incoming Cases (and various attributes thereof) (506), Average Speed to Answer (a VoIP or video call or private direct messaging thread, as the case may be) (508), Incoming Calls (510, 514), Live Chat Capacity (showing live (i.e., real-time) data) (512), trending tags (516) that are being used frequently by other agents in the performance of their roles as customer support or service agents, online agents (again, live data showing which agents working for a brand (i.e., brand entities 222-226 (FIG. 2)) are handling active calls or private direct messaging threads, and others, without limitation or restriction. Interface 500 may also be configured to show statistical historical information that can be used to analyze an agent's performance to help improve customer service and the perception of a brand (i.e., brand entities 222-226 (FIG. 2)) engaging with users (i.e., user account 238 (FIG. 2)). In other examples, the configuration, layout, function, and structure of the elements of interface 400 as shown may be varied, without limitation or restriction.

FIG. 6 illustrates an exemplary process for multi-modal data transfer and handling. Here, process 600 initiates by beginning a public conversation thread (e.g., on messaging application/platform 228 (FIG. 2)) when a user account (e.g., user account 238 (FIG. 2)) initiates a message (i.e., a data transfer from one or more of clients 106-114 (FIG. 1)) that is transmitted over a data network (e.g., data network 120 (FIG. 1), data networks 218-220 (FIG. 2), or others, not shown and described, but without limitation or restriction) to messaging application platform 228 (602). In some examples, user account 238 may be implemented when a client application (not shown) is downloaded and installed on a client device (e.g., clients 106-114 (FIG. 1)) such as, for example, X™ on a mobile computing or communication device, which may include smart phones, portable computers, laptops, tablet computers, smart watches, wearable devices, and many others, without limitation or restriction.

Once initiated, a public conversation thread is evaluated to detect data associated with the public conversation thread (i.e., “public conversation data,” “public conversation thread data,” which may be used interchangeably throughout this Detailed Description) is being directed by a user account (i.e., individual account) to an entity (e.g., brand, organization, corporate entity, individual, or any provider of a good or service or a market maker for a good or service) (604). As an example, public conversation data thread data (i.e., hereafter “public conversation thread,” “public conversation data thread,” or “public conversation thread data,” all of which may be used interchangeably without limitation or restriction) transferred between one or more of clients 106-114 (FIG. 1) hosting user account 238 (FIG. 2) and messaging application/platform 228 (FIG. 2) can be evaluated by multi-modal platform (i.e., multi-modal data transfer and handling platform) 202 (FIG. 2). Data transferred to messaging application/platform 228 may, if public conversation data thread data associated with a brand entity (e.g., one or more of brand entities 222-226 (FIG. 2)) is detected, be seamlessly transferred or switched from messaging application/platform 228 to multi-modal platform 202 to establish other types of communication links between user account 238 and one or more of brand entities 222-226 (FIG. 2). In other words, a private direct messaging thread may be established between an individual account (i.e., user account 238 (FIG. 2)) and an entity (i.e., brand entity 222-226) (606).

As an example, if messaging application/platform 228 detected in public conversation data thread data that a given user (e.g., user account 218 (FIG. 2)) is discussing Nike DS Sky Elite “Tokyo” volleyball shoes, call module 236 may initiate a data service call to multi-modal platform 202 to establish a voice communication link with customer support or product sales agents of Nike, Inc. of Beaverton Oregon (e.g., which may be one or more of brand entities 222-226 (FIG. 2)), which may be instituted using Voice-over-Internet-Protocol (a data communication protocol for coding/decoding data to render audio data between two or more endpoints using IP data communication networks and topologies).

Referring back to FIG. 6, a decision is made as to whether data indicating a request to establish a communication link (e.g., voice, text, video, multi-media, or others, without limitation or restriction) with an entity (i.e., brand entity 222-226 (FIG. 2)) (608). If such data is detected, then the private direct messaging thread established in 606 is transferred from messaging application/platform 228 (FIG. 2) to multi-modal platform 202 (FIG. 2) (610). Once transferred, data monitoring (e.g., data sampling, packet sniffing, or other data monitoring techniques) is initiated to transfer other private direct messaging threads between messaging application/platform 228 and multi-modal platform 202 to convert detected public conversation data thread data associated with an entity to private direct messaging options for communication with an entity (e.g., brand entities 222-226) (612). If a decision is made that no data is detected requesting transfer of a private direct messaging thread to a brand (e.g., brand entities 222-226 (FIG. 2)), then process 600 ends. In some examples, a user (e.g., user account 238 (FIG. 2)) may not desire to communicate with an agent, as described above in connection with FIGS. 4A-4C, 5, but instead wishes to remain within a public conversation data thread. If no data is detected requesting to transfer a private direct messaging thread to a brand, then process 600 ends. In other examples, no private direct messaging thread is established or sought and thus no data transfer between messaging application/platform 228 and multi-modal platform 202 needs to occur. In still other examples, process 600 may be varied in order, function, structures configured to perform functions, the number of functions or sub-functions, or other aspects, and is not limited to the examples shown or described herein.

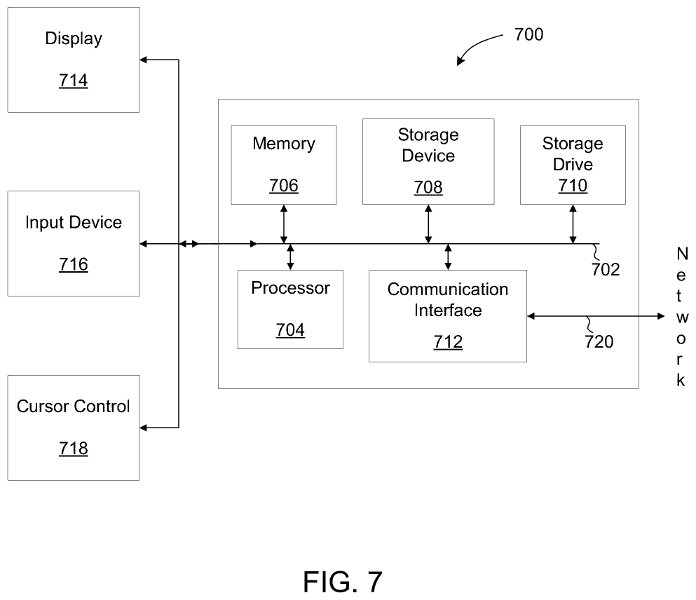

FIG. 7 illustrates an exemplary computer system suitable for multi-modal data transfer and handling. In some examples, computer system 700 may be used to implement computer programs, applications, methods, processes, or other software stored on or executed from a non-transitory medium to perform the above-described techniques. Computer system 700 includes a bus 702 or other communication mechanism for communicating information, which interconnects subsystems and devices, such as processor 704, system memory 706 (e.g., RAM), storage device 708 (e.g., ROM), storage drive 710 (e.g., magnetic, optical, quantum, or others, without limitation or restriction), communication interface 712 (e.g., modem or Ethernet card), display 714 (e.g., CRT or LCD), input device 716 (e.g., keyboard), and cursor control 718 (e.g., mouse or trackball).

According to some examples, computer system 700 performs specific operations by processor 704 executing one or more sequences of one or more instructions stored in system memory 706. Such instructions may be read into system memory 706 from another computer readable medium, such as static storage device 708 or storage drive 710. In some examples, hard-wired circuitry may be used in place of or in combination with software instructions for implementation.

The term “computer readable medium” refers to any tangible medium that participates in providing instructions to processor 704 for execution. Such a medium may take many forms, including but not limited to, non-volatile media and volatile media. Non-volatile media includes, for example, optical or magnetic disks, such as storage drive 710. Volatile media includes dynamic memory, such as system memory 706.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 702 for transmitting a computer data signal.

In some examples, execution of the sequences of instructions may be performed by a single computer system 700. According to some examples, two or more computer systems 700 coupled by communication link 720 (e.g., LAN, PSTN, or wireless network) may perform the sequence of instructions in coordination with one another. Computer system 700 may transmit and receive messages, data, and instructions, including program, i.e., application code, through communication link 720 and communication interface 712. Received program code may be executed by processor 704 as it is received, and/or stored in storage drive 710, or other non-volatile storage for later execution.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method, comprising:
initiating a public conversation data thread between an account and an entity using a messaging application;
detecting a public conversation thread data request being directed by the account to the entity;
initiating a private direct messaging data thread between the account and the entity in response to the public conversation thread data request; and
detecting a transfer request from the account, the transfer request being configured to responsively transfer the public conversation data thread between the account and the entity to the private direct messaging data thread between the account and the entity to a platform using a multi-modal service envelope.

2. The method of claim 1, wherein the account is associated with a social media application.

3. The method of claim 1, wherein the public conversation data thread comprises an electronic data communication session between two or more devices in data communication over one or more data networks, the public conversation data thread being viewable on a social media network used by the account.

4. The method of claim 1, wherein the public conversation data thread comprises an electronic data communication session between two or more devices in data communication over one or more data networks, the public conversation data thread being viewable on a social media network used by the entity.

5. The method of claim 1, wherein the entity is a brand entity.

6. The method of claim 1, wherein the multi-modal service envelope is provided by the platform and the platform is configured to transfer the public conversation data thread to the private direct messaging data thread when a request is detected at an interface.

7. The method of claim 1, wherein the public conversation data thread is a text messaging thread.

8. The method of claim 1, wherein the messaging application is a mobile application.

9. The method of claim 1, wherein the public conversation data thread is hosted on a text messaging application configured to host the public conversation data thread between a mobile device and an application server, the public conversation data thread being published on the messaging application.

10. The method of claim 1, wherein the public conversation data thread is a text messaging thread transferring data between a mobile device and an application server, the public conversation data thread being published on the messaging application and visible to another account on the messaging application.

11. The method of claim 1, further comprising transferring the public conversation data thread from the messaging application to another application, the another application being managed by the entity and instantiated using the platform.

12. The method of claim 1, wherein the platform is a multi-modal platform.

13. A system, comprising:
a database configured to store data used by a platform implementing a multi-modal service envelope; and
a processor configured to initiate a public conversation thread between an account and an entity using a messaging application, to detect a public conversation thread data request being directed by the account to the entity, to initiate a private direct messaging thread between the account and the entity in response to the public conversation thread data request, and to detect a transfer request from the account, the transfer request being configured to responsively transfer the public conversation thread between the account and the entity to the private direct messaging thread between the account and the entity to a platform using a multi-modal service envelope.

14. The system of claim 13, wherein the messaging application receives one or more signals from the platform.

15. The system of claim 13, wherein the platform is a multi-modal platform.

16. The system of claim 13, wherein the entity is a brand entity having one or more accounts hosted on the messaging application to be managed by the platform, the platform being multi-modal.

17. The system of claim 13, wherein the transfer request comprises transfer request data to transfer the public conversation thread to the private direct messaging thread on the platform.

18. The system of claim 13, wherein the transfer request sends a signal to invoke a voice module to generate a voice communication link between the account and the brand.

19. The system of claim 13, wherein the transfer request sends a signal to invoke a video module to transfer the public conversation thread to the private direct messaging thread, the private direct messaging thread being a video exchange between the account and the entity.

20. A non-transitory computer readable medium having one or more computer program instructions configured to perform a method, the method comprising:
initiating a public conversation thread between an account and an entity using a messaging application;
detecting a public conversation thread data request being directed by the account to the entity;
initiating a private direct messaging thread between the account and the entity in response to the public conversation thread data request; and
detecting a transfer request from the account, the transfer request being configured to responsively transfer the public conversation thread between the account and the entity to the private direct messaging thread between the account and the entity to a platform using a multi-modal service envelope.
